(19) United States
(12) Patent Application Publication
(10) Pub. No.: US 2025/0201877 A1
(43) Pub. Date: Jun. 19, 2025

(54) COLD START CONTROL METHOD OF FUEL CELL STACK AND COLD START SYSTEM OF FUEL CELL STACK

(71) Applicants: Hyundai Motor Company, Seoul (KR); Kia Corporation, Seoul (KR)

(72) Inventor: Ki Chul Shin, Seoul (KR)

(21) Appl. No.: 18/657,997

(22) Filed: May 8, 2024

(30) Foreign Application Priority Data
Dec. 19, 2023 (KR) 10-2023-0185948

(51) Int. Cl. H01M 8/04302; H01M 8/04082; H01M 8/0432; H01M 8/04537; H01M 8/04701; H01M 8/04746

(52) U.S. Cl. CPC H01M 8/04302; H01M 8/04201; H01M 8/04358; H01M 8/04559; H01M 8/04701; H01M 8/04753

(57) ABSTRACT

A cold start control method of a fuel cell stack, and system thereof, can include determining by a controller whether cold start is required, opening an air cut-off valve by the controller when the cold start is required, determining by the controller whether an output voltage of a fuel cell stack is recovered, and satisfying a cold start completion criteria of the fuel cell stack by controlling an opening amount of the air cut-off valve when the output voltage of the fuel cell stack is recovered.

### CROSS-REFERENCE TO RELATED APPLICATIONS

The present application claims priority to Korean Patent Application No. 10-2023-0185948, filed Dec. 19, 2023, the entire contents of which is incorporated herein for all purposes by this reference.

### TECHNICAL FIELD

The present disclosure relates to a cold start control method of a fuel cell stack and a cold start system of a fuel cell stack.

### BACKGROUND

A fuel cell is a device that receives hydrogen and air from an outside and generates electrical energy through an electrochemical reaction inside a fuel cell stack. The fuel cell can be used as a power source in various fields, such as fuel cell electric vehicles (FCEV) and fuel cells for power generation.

The fuel cell stack built into a fuel cell vehicle is sensitive to the temperature of the outside air, and in particular, power generation efficiency is significantly reduced at low temperatures. In addition, the water produced by the reaction of hydrogen and oxygen in the fuel cell stack freezes, adversely affecting the durability of the fuel cell stack.

Accordingly, in case where the temperature of the outside air is low, the fuel cell vehicle performs low-temperature start (cold start). The cold start utilizes loads such as a heating element (COD), air compressor (ACP), and high-voltage battery within the fuel cell system to raise the temperature of the fuel cell stack and induces heat generation from the fuel cell stack and loads to achieve a stable temperature increase.

Conventionally, the cold start of the fuel cell stack was performed by opening all air cut-off valves (ACPs) of the air supply system during cold start. This causes the cold air from the outside air to continuously flow into the fuel cell stack, causing the water produced within the fuel cell stack to freeze quickly. As a result, there is a problem that the reaction area where hydrogen and oxygen react within the fuel cell stack is reduced, so it takes a long time to reach the cold start completion condition, or even cold start failure may often occur.

The information disclosed in this Background section is only for enhancement of understanding of the general background of the present disclosure and should not be taken as an acknowledgement that this information forms the prior art already publicly known, available, or in use.

### SUMMARY

The present disclosure relates to a cold start control method of a fuel cell stack and a cold start system of a fuel cell stack.

Some embodiments of the present disclosure can solve the above problems by providing a cold start control method for a fuel cell stack that can stably perform the cold start of the fuel cell stack.

A cold start control method of a fuel cell stack according to an embodiment of the present disclosure can include: determining by a controller whether cold start is required; opening an air cut-off valve by the controller when the cold start is required; determining by the controller whether an output voltage of a fuel cell stack is recovered; and satisfying a cold start completion criteria of the fuel cell stack by controlling an opening amount of the air cut-off valve when the output voltage of the fuel cell stack is recovered.

In determining whether the cold start is required, whether the cold start is required may be determined based on one or more of a temperature of an outside air and temperature of coolant.

In opening the air cut-off valve, the air cut-off valve may be opened to a maximum.

In determining whether the output voltage is recovered, whether the output voltage is recovered may be determined based on whether the output voltage of the fuel cell stack is maintained at or greater than a reference voltage and for a reference time or longer than the reference time.

The satisfying a cold start completion criteria of the fuel cell stack by controlling an opening amount of the air cut-off valve may include: monitoring one or more of the output voltage, output current, cell voltage deviation, coolant temperature, and air outlet temperature of the fuel cell stack by the controller; increasing a heat generation amount of the fuel cell stack by reducing the opening amount of the air cut-off valve; and preventing shutdown of the fuel cell stack by increasing the opening amount of the air cut-off valve.

In increasing the heat generation amount of the fuel cell stack, a driving speed of the air compressor may be controlled to be constant and the opening amount of the air cut-off valve may be reduced at a constant angular speed.

In preventing the shutdown of the fuel cell stack, a driving speed of the air compressor may be controlled to be constant, and the opening amount of the air cut-off valve may be increased at a constant angular speed.

The driving speed of the air compressor may be maintained the same as in the step of increasing the heat generation amount of the fuel cell stack, and the opening speed of the air cut-off valve may be faster than a closing speed.

In satisfying the cold start completion criteria of the fuel cell stack by controlling the opening amount of the air cut-off valve, the increasing the heat generation amount of the fuel cell stack and the preventing the shutdown of the fuel cell stack may be performed repeatedly, and the cold start of the fuel cell stack may be performed.

When the output voltage of the fuel cell stack is maintained at a first voltage or less for a first time or more or the cell voltage deviation of the fuel cell stack is maintained at a first voltage deviation or greater for the first time or more, the preventing the shutdown of the fuel cell stack may be performed.

When the output voltage of the fuel cell stack is maintained at a second voltage or greater for a second time or more or the cell voltage deviation of the fuel cell stack is maintained at a second voltage deviation or less for the second time or more, the increasing the heat generation amount of the fuel cell stack may be performed.

The controller may monitor one or more of the output voltage, output current, cell voltage deviation, coolant temperature, and air outlet temperature of the fuel cell stack, and terminate the cold start when the cold start completion criteria is satisfied.

A cold start system of a fuel cell stack according to an embodiment of the present disclosure may include an air supply system including: an air compressor and an air cut-off valve; and a controller that determines whether cold start is required, opens the air cut-off valve when the cold start is required, determines whether an output voltage of the fuel cell stack is recovered, and satisfies a cold start completion criteria of the fuel cell stack by controlling an opening amount of the air cut-off valve when the output voltage of the fuel cell stack is recovered.

The controller may monitor one or more of the output voltage, output current, cell voltage deviation, coolant temperature, and air outlet temperature of the fuel cell stack, increase a heat generation amount of the fuel cell stack by closing the air cut-off valve according to a monitoring result or prevents shutdown of the fuel cell stack by opening the air cut-off valve, and terminate the cold start of the fuel cell stack according to the monitoring result.

According to the cold start control method of the fuel cell stack of an embodiment of the present disclosure, there is an advantage that the cold start of the fuel cell stack can be performed stably.

### BRIEF DESCRIPTION OF THE DRAWINGS

FIGS. 1 to 3 are flowcharts of a cold start control method of a fuel cell stack according to an embodiment of the present disclosure.

FIGS. 4 and 5 are configuration diagrams for explaining a cold start system of a fuel cell stack according to an embodiment of the present disclosure.

### DETAILED DESCRIPTION OF ILLUSTRATIVE EMBODIMENTS

Hereinafter, example embodiments of the present disclosure will be described in detail with reference to the attached drawings. Same or similar components can be given same reference numbers and redundant description thereof can be omitted.

In the following description, if a detailed description of known techniques associated with the example embodiments of the present disclosure would unnecessarily obscure the gist of the embodiments, detailed description thereof can be omitted. In addition, the attached drawings are provided for easy understanding of example embodiments of the present disclosure and do not necessarily limit technical spirits of the present disclosure, and potential embodiments can be construed as including all modifications, equivalents, and alternatives falling within the spirit and scope of the present disclosure.

While terms, such as “first”, “second”, etc., may be used to describe various components, such components are not necessarily limited by such terms. Such terms can be used merely to distinguish one component from another.

The singular forms are intended to include the plural forms as well, unless the context clearly indicates otherwise.

In the specification, it can be further understood that the terms “comprise” and “include” specify the presence of stated features, integers, steps, operations, elements, components, and/or combinations thereof, but do not preclude in advance the presence or addition of one or more other features, integers, steps, operations, elements, components, and/or combinations.

A controller may include a communication device configured to communicate with other controllers or sensors, a memory (storage medium) configured to store instructions, operating system, logic commands, input and output information, etc., and at least one processor configured to perform determination, calculation, judgement, etc., necessary to control a function assigned to the controller so as to control the function.

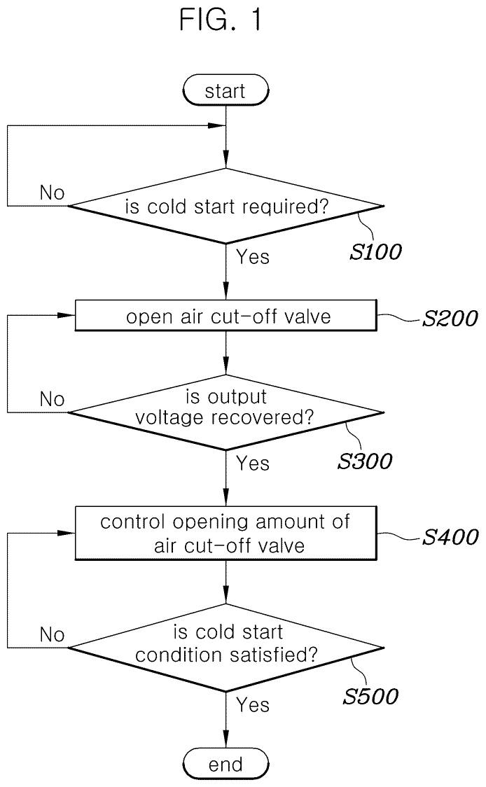

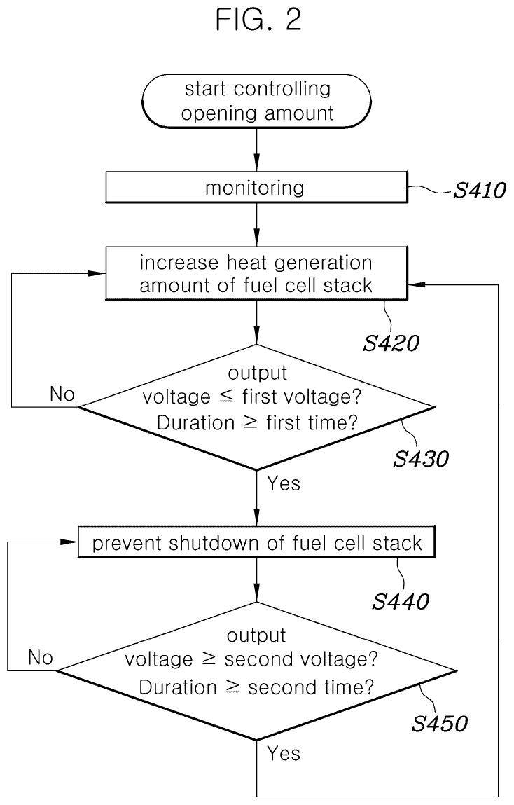

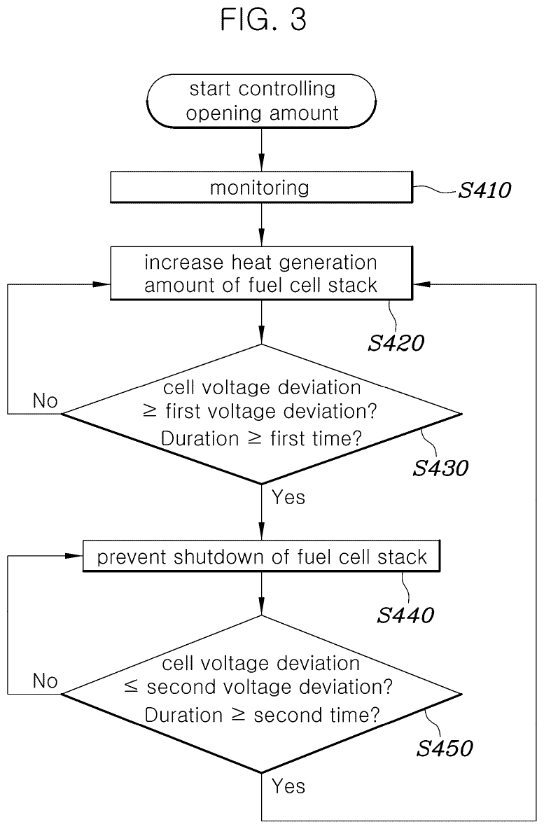

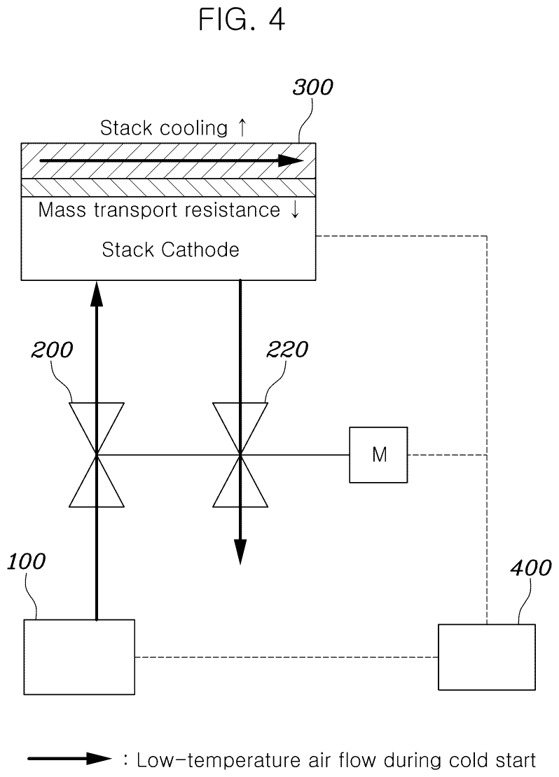

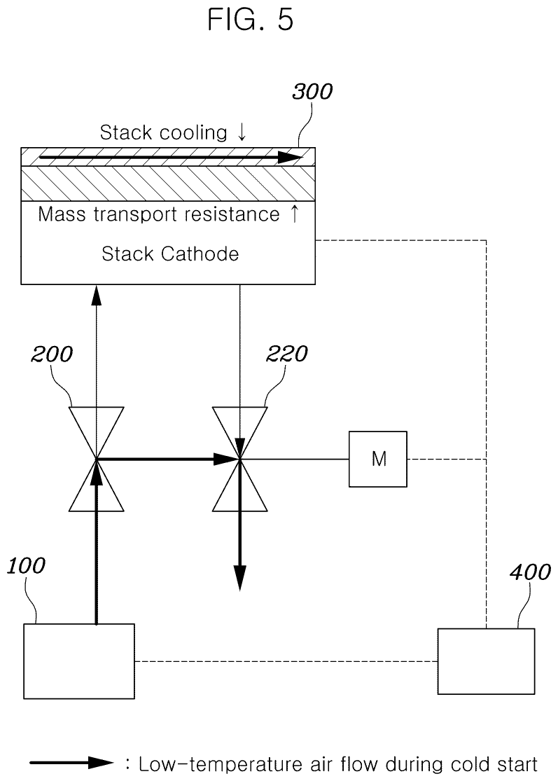

FIGS. 1 to 3 are flowcharts of a cold start control method of a fuel cell stack according to an embodiment of the present disclosure. FIGS. 4 and 5 are configuration diagrams for explaining a cold start system of a fuel cell stack according to an embodiment of the present disclosure.

Referring to FIGS. 1 to 5, example embodiments of the present disclosure will be described.

A cold start control method of a fuel cell stack according to an embodiment of the present disclosure can include the steps of determining by a controller 400 whether cold start is required (operation S100); opening an air cut-off valve 200 by the controller 400 when the cold start is required (operation S200); determining by the controller 400 whether an output voltage of a fuel cell stack 300 is recovered (operation S300); and satisfying a cold start completion criteria of the fuel cell stack 300 by controlling an opening amount of the air cut-off valve 200 when the output voltage of the fuel cell stack 300 is recovered (operation S400).

In the step of determining by the controller 400 whether the cold start of the fuel cell stack 300 is required (operation S100), it may be determined by an outside temperature sensor, a coolant temperature sensor, etc. provided in the fuel cell system. For example, when the temperature of the outside air is 4° C. or lower, it may be determined that the cold start is required, or when the coolant temperature is 10° C. or lower, it may be determined that the cold start is required.

When the controller 400 determines that the cold start is required, the controller 400 can perform the step of opening the air cut-off valve 200 to recover the output voltage of the fuel cell stack 300 (operation S200). The recovery of the output voltage of the fuel cell stack 300 can be that the output voltage of the fuel cell stack can be generated up to a voltage value that can minimally drive the various accessories (converter, air compressor, battery, etc.) that constitute the fuel cell system.

That is, at the beginning of cold start, a voltage may rise quickly due to a chemical reaction within the fuel cell stack 300, but the produced water at the beginning of starting can freeze quickly, and the frozen produced water reduces the reaction area where oxygen and hydrogen reacts within the fuel cell stack 300. Accordingly, the performance of the fuel cell stack 300 decreases. The air compressor 100 can be driven to inject air into the fuel cell stack 300 so that the output voltage of the fuel cell stack 300 can be recovered again, and accordingly, the output voltage of the fuel cell stack 300 may increase again.

It can be preferable to open the air cut-off valve 200 to the maximum. Low-temperature air can continue to flow into the fuel cell stack 300 due to the maximum opening of the air cut-off valve 200. However, because the reaction between hydrogen and oxygen is essential for recovering the output voltage of the fuel cell stack 300, it can be useful to recover the output voltage of the fuel cell stack 300 in the shortest possible time.

After opening the air cut-off valve 200, the controller 400 may monitor the output voltage of the fuel cell stack 300 to determine whether the output voltage is recovered. In the step of determining whether the output voltage is recovered (operation S300), whether the output voltage is recovered may be determined based on whether the output voltage of the fuel cell stack 300 is maintained at or greater than a reference voltage and for a reference time or longer than the reference time.

For example, the reference voltage may be set between 250V and 300V, and the reference voltage may be a voltage that can minimally drive various accessories provided in the fuel cell system.

When the recovery of the output voltage of the fuel cell stack 300 is completed, the step of controlling the opening amount of the air cut-off valve can be performed to perform a full-fledged cold start of the fuel cell stack 300 (operation S400).

The step of satisfying the cold start completion criteria of the fuel cell stack may include the steps of monitoring one or more of the output voltage, output current, cell voltage deviation, coolant temperature, and air outlet temperature of the fuel cell stack 300 by the controller 400 (operation S410); increasing a heat generation amount of the fuel cell stack 300 by reducing the opening amount of the air cut-off valve 200 (operation S420); and preventing shutdown of the fuel cell stack 300 by increasing the opening amount of the air cut-off valve 200 (operation S440).

To determine whether the cold start of the fuel cell stack 300 is complete, in the step of satisfying the cold start completion criteria of the fuel cell stack 300 (operation S400), the controller 400 may continuously monitor one or more of the output voltage, output current, cell voltage deviation, coolant temperature, and air outlet temperature of the fuel cell stack 300. While performing the step of controlling the opening amount of the air flow rate control valve 200 (operation S400), which will be described later, when the cold start completion criteria is satisfied (operation S500) as a result of monitoring, the cold start may be terminated.

When the output voltage of the fuel cell stack 300 is recovered, the step of increasing the heat generation amount of the fuel cell stack (operation S420) may be performed first. To increase the heat generation amount of the fuel cell stack 300, an embodiment of the present disclosure can intentionally reduce the opening amount of the air cut-off valve 200 to reduce the flow rate of air flowing into the fuel cell stack 300. As a result, an increase in output voltage of the fuel cell stack 300 can be delayed due to an increase in mass transport resistance inside the fuel cell stack 300, and the heat generation amount of the fuel cell stack 300 can naturally increase.

Specifically, in the step of increasing the heat generation amount of the fuel cell stack 300 (operation S420), the controller 400 can control the driving speed of the air compressor 100 and can reduce the opening amount of the air cut-off valve 200 at a constant angular speed. The reducing the opening amount of the air cut-off valve 200 can be to increase the heat generation amount of the fuel cell stack 300 by increasing the mass transport resistance.

Referring to FIGS. 4 and 5, when an excessive amount of low-temperature air is introduced during cold start as shown in FIG. 4, the heat generation of the fuel cell stack 300 may be suppressed by the low-temperature air. Also, as shown in FIG. 5, if excessive low-temperature air is bypassed during cold start and only a small amount of air is supplied to the fuel cell stack 300, mass transport resistance can increase and the heat generation amount of the fuel cell stack 300 can increase.

However, maintaining the driving speed of the air compressor 100 at a constant speed can be to prevent loss of the reaction area due to freezing of the produced water in the fuel cell stack 300 by reducing the flow rate of low-temperature air flowing into the fuel cell stack 300 as time passes.

It can be preferable to set the driving speed of the air compressor 100 to a driving speed that can continuously generate the output current generated by the fuel cell stack 300 during cold start.

Specifically, the controller 400 of the fuel cell system may store a data map for the flow rate supplied to the fuel cell stack 300 according to the opening amount of the air cut-off valve 200 and the speed of the air compressor 100. The controller 400 may use the data map to control the driving speed of the air compressor 100 and the opening amount of the air cut-off valve 200 to satisfy the required output of the fuel cell stack 300.

During cold start of the fuel cell stack 300, most of the output generated from the fuel cell stack 300 can be transmitted to a battery. After the output voltage of the fuel cell stack 300 is recovered, the output voltage and output current generated by the fuel cell stack 300 can be applied to the battery. The controller 400 may control the air compressor 100 to be driven at a driving speed that may continuously generate the output current currently output from the fuel cell stack 300, and the controller 400 may control the opening amount of the air cut-off valve 200 to be gradually closed.

For example, during cold start of the fuel cell stack 300, when the output voltage of the fuel cell stack 300 is recovered and the output current applied to the battery is 60 A, the controller 400 may determine the air flow rate capable of continuously generating the output current of 60 A, and then determine the opening amount of the air cut-off valve 200 and the driving speed of the air compressor 100 to inject the corresponding flow rate into the fuel cell stack 300. The air cut-off valve 200 can be gradually closed, and the driving speed of the air compressor 100 can be maintained constant. Thus, it can be preferable that the driving speed of the air compressor 100 from the beginning is determined at a constant speed, for example, 60000 rpm or more.

The closing angular velocity of the air cut-off valve 200 may be determined between 0.1 degree/see and 1.0 degree/see, for example. In addition, to prevent the air cut-off valve 200 from being completely closed, the minimum opening angle of the air cut-off valve 200 can be preferably set to 0.5 degrees to 1.0 degrees.

Although the heat generation amount of the fuel cell stack 300 can be increased through the above control, if the air cut-off valve 200 is continuously kept closed, the increase in voltage of the fuel cell stack 300 can be significantly delayed. Alternatively, if the cell voltage deviation of the fuel cell stack 300 exceeds a significant value, it may lead to shutdown of the fuel cell stack 300. Therefore, the step of increasing the heat generation amount of the fuel cell stack 300 (operation S420) preferably can be processed at the step of preventing shutdown of the fuel cell stack (operation S440).

In the step of preventing shutdown of the fuel cell stack 300 (operation S440), the opening amount of the air cut-off valve 200 may be increased at a constant angular speed while the driving speed of the air compressor 100 can be controlled to be constant. To prevent shutdown of the fuel cell stack 300, the air cut-off valve 200 may be gradually opened to supply low-temperature air into the fuel cell stack 300. Accordingly, the heat generation of the fuel cell stack 300 can be suppressed by supplying low-temperature air, but the output voltage generated by the fuel cell stack 300 can increase and the cell voltage deviation can decrease, resulting in preventing the shutdown of the fuel cell stack 300.

In the step of preventing the shutdown of the fuel cell stack 300 (operation S440), the driving speed of the air compressor 100 can be maintained the same as in the step of increasing the heat generation amount of the fuel cell stack 300 (operation S420), but it can be preferable that the opening speed of the air cut-off valve 200 is controlled faster than the closing speed.

When the fuel cell stack 300 is shutdown, the cold start must be performed again. Thus, because it can be a critical situation that the fuel cell stack 300 is shut down midway, it can be preferred to quickly open the air cut-off valve 200 to prevent the shutdown of the fuel cell stack 300.

For example, if the closing angular velocity of the air cut-off valve 200 is determined between 0.1 degree/sec and 1.0 degree/sec, the opening angular velocity may be determined between 0.2 degree/sec and 2.0 degree/sec. Further, it can be desirable that the angular velocity is determined to be 1.5 times or more than the closing angular velocity.

As described above, in the cold start of the fuel cell stack 300, the step of increasing the heat generation amount of the fuel cell stack (operation S420) and the step of preventing the shutdown of the fuel cell stack (operation S440) can be performed repeatedly, thereby causing the fuel cell stack 300 to be completed when the cold start completion condition is satisfied (operation S500).

Accordingly, if the specific condition is satisfied, the step of increasing the heat generation amount of the fuel cell stack 300 (operation S420) can be processed at the step of preventing the shutdown of the fuel cell stack 300 (operation S440). Alternatively, if the specific condition is satisfied, the step of preventing the shutdown of the fuel cell stack 300 (operation S440) can be processed at the step of increasing the heat generation amount of the fuel cell stack 300 (operation S420), so that the cold start of the fuel cell stack 300 may be performed.

Specifically, it can be determined whether the output voltage of the fuel cell stack 300 is maintained at a first voltage or less for a first time or more or the cell voltage deviation of the fuel cell stack is maintained at a first voltage deviation or greater for the first time or more (operation S430). If this is satisfied (yes at operation S430), the step of preventing the shutdown of the fuel cell stack 300 (operation S440) may be performed. The first voltage can refer to a voltage at which the accessories of the fuel cell system cannot operate. That is, the first voltage can be a voltage of about 270V or less, which can be lower than the driving voltage.

The controller 400 can continuously monitor one or more of the output voltage, output current, cell voltage deviation, coolant temperature, and air outlet temperature of the fuel cell stack 300, and determine whether the monitored output voltage or cell voltage deviation of the fuel cell stack 300 is maintained for a certain period of time or more. If this is satisfied, the process may proceed to the step of preventing the shutdown of the fuel cell stack 300 (operation S440).

Conversely, the controller 400 can determine whether the output voltage of the fuel cell stack 300 is maintained at a second voltage or greater for a second time or more or the cell voltage deviation of the fuel cell stack 300 is maintained at a second voltage deviation or less for the second time or more (operation S450). If this is satisfied, the step of increasing the heat generation amount of the fuel cell stack (operation S420) may be performed. Here, the second voltage can be a voltage at which the fuel cell stack is determined to have sufficiently generated heat and can refer to a voltage of about 300 V or greater, for example. Alternatively, the second voltage can refer to a voltage at which sufficient power is generated in the fuel cell stack and sufficient current is output.

The controller 400 can continuously monitor one or more of the output voltage, output current, cell voltage deviation, coolant temperature, and air outlet temperature of the fuel cell stack 300, and if the monitored output voltage or cell voltage deviation of the fuel cell stack 300 is maintained for a certain period of time or more, the process may proceed to the step of increasing the heat generation amount of the fuel cell stack 300 (operation S420).

The controller 400 may continuously monitor one or more of the output voltage, output current, cell voltage deviation, coolant temperature, and air outlet temperature of the fuel cell stack 300 to increase heat generation (operation S420), and when the cold start completion condition is satisfied, the cold start can be finally terminated.

A cold start system of a fuel cell stack according to an embodiment of the present disclosure may include an air supply system including: the air compressor 100 and the air cut-off valve 200; and the controller 400 that determines whether cold start is required, opens the air cut-off valve 200 when the cold start is required, determines whether an output voltage of the fuel cell stack 300 is recovered, and satisfies a cold start completion criteria of the fuel cell stack by controlling an opening amount of the air cut-off valve 200 when the output voltage of the fuel cell stack 300 is recovered.

The controller 400 may monitor one or more of the output voltage, output current, cell voltage deviation, coolant temperature, and air outlet temperature of the fuel cell stack 300, increase the heat generation amount of the fuel cell stack 300 by closing the air cut-off valve 200 according to the monitoring result or prevent shutdown of the fuel cell stack 300 by opening the air cut-off valve 200, and terminate the cold start of the fuel cell stack 300 according to the monitoring result.

Although the present disclosure has been illustrated and described in connection with the specific example embodiments and the accompanying drawings, it can be readily understood by those skilled in the art that various modifications and changes can be made thereto without departing from the spirit and scope of the present disclosure defined by the appended claims.

What is claimed is:

1. A cold start control method of a fuel cell stack, comprising:
determining whether a cold start is required;
opening an air cut-off valve in response to the cold start being required;
determining whether an output voltage of the fuel cell stack is recovered; and
satisfying a cold start completion criteria of the fuel cell stack by controlling an opening amount of the air cut-off valve in response to the output voltage of the fuel cell stack being recovered.

2. The method of claim 1, wherein the determining whether the cold start is required is based on one of or both of an air temperature of an outside air and a coolant temperature of a coolant.

3. The method of claim 1, wherein the opening the air cut-off valve, comprises opening the air cut-off valve to a maximum.

4. The method of claim 1, wherein the determining whether the output voltage is recovered is based on whether the output voltage of the fuel cell stack is maintained at or greater than a reference voltage and for a reference time or longer than the reference time.

5. The method of claim 1, wherein the controlling the opening amount of the air cut-off valve comprises:
monitoring one of or any combination of the output voltage, an output current, a cell voltage deviation, a coolant temperature, and an air outlet temperature of the fuel cell stack;
increasing a heat generation amount of the fuel cell stack by reducing the opening amount of the air cut-off valve; and
preventing shutdown of the fuel cell stack by increasing the opening amount of the air cut-off valve.

6. The method of claim 5, wherein the increasing of the heat generation amount of the fuel cell stack comprises:
controlling a driving speed of an air compressor to be constant; and
reducing the opening amount of the air cut-off valve at a constant angular speed;
wherein the preventing the shutdown of the fuel cell stack comprises:
controlling a driving speed of an air compressor to be constant; and
increasing the opening amount of the air cut-off valve at a constant angular speed.

7. The method of claim 6, wherein the driving speed of the air compressor is equal to the driving speed of the air compressor in the increasing the heat generation amount of the fuel cell stack, and wherein the constant angular speed of the opening amount of the air cut-off valve is faster than a closing speed thereof.

8. The method of claim 5, wherein the satisfying of the cold start completion criteria of the fuel cell stack by controlling of the opening amount of the air cut-off valve, the increasing of the heat generation amount of the fuel cell stack, and the preventing of the shutdown of the fuel cell stack, are performed repeatedly, and the cold start of the fuel cell stack is performed.

9. The method of claim 8, wherein the preventing the shutdown of the fuel cell stack is performed in response to the output voltage of the fuel cell stack being maintained at a first voltage or less for a first time or more, or in response to the cell voltage deviation of the fuel cell stack being maintained at a first voltage deviation or greater for the first time or more; and
wherein the increasing of the heat generation amount of the fuel cell stack is performed in response to the output voltage of the fuel cell stack being maintained at a second voltage or greater for a second time or more, or in response to the cell voltage deviation of the fuel cell stack being maintained at a second voltage deviation or less for the second time or more.

10. The method of claim 1, further comprising:
monitoring one of or any combination of the output voltage, an output current, a cell voltage deviation, a coolant temperature, and an air outlet temperature of the fuel cell stack; and
terminating the cold start in response to the cold start completion criteria being satisfied.

11. A cold start system of a fuel cell stack, comprising:
an air supply system including an air compressor and an air cut-off valve; and
one or more controllers; and
a storage medium storing computer-readable instructions that, when executed by the one or more controllers, enable the one or more controllers to:
determine whether a cold start is required,
open the air cut-off valve in response to the cold start being required,
determine whether an output voltage of the fuel cell stack is recovered, and
satisfy a cold start completion criteria of the fuel cell stack by controlling an opening amount of the air cut-off valve in response to the output voltage of the fuel cell stack being recovered.

12. The system of claim 11, wherein the instructions enable the one or more controllers to determine whether the cold start is required based on one of or both of a temperature of an outside air or a temperature of a coolant.

13. The system of claim 11, wherein the instructions further enable the one or more controllers to open the air cut-off valve to a maximum when the cold start is required.

14. The system of claim 11, wherein the instructions enable the one or more controllers to determine whether the output voltage is recovered based on whether the output voltage of the fuel cell stack is maintained at or greater than a reference voltage and for a reference time or longer than the reference time.

15. The cold start system of claim 11, wherein the instructions further enable the one or more controllers to:
monitor one of or any combination of the output voltage, an output current, a cell voltage deviation, a coolant temperature, and an air outlet temperature of the fuel cell stack;
increase a heat generation amount of the fuel cell stack by closing the air cut-off valve according to a monitoring result or prevent shutdown of the fuel cell stack by opening the air cut-off valve; and
terminate the cold start of the fuel cell stack according to the monitoring result.

16. The system of claim 11, wherein the instructions enable the one or more controllers to constantly control a driving speed of the air compressor and to increase a heat generation amount of the fuel cell by reducing the opening amount of the air cut-off valve at a constant angular speed; and
wherein the instructions enable the one or more controllers to constantly control the driving speed of the air compressor and to prevent shutdown of the fuel cell stack by increasing the opening amount of the air cut-off valve at the constant angular speed.

17. The system of claim 16, wherein the driving speed of the air compressor is equal to the driving speed of the air compressor in the increasing the heat generation amount of the fuel cell stack, and wherein the constant angular speed of the opening amount of the air cut-off valve is faster than closing speed thereof.

18. The system of claim 11, wherein the instructions enable the one or more controllers to perform the cold start of the fuel cell stack by repeatedly increasing a heat generation amount of the fuel cell stack and preventing shutdown of the fuel cell stack.

19. The system of claim 18, wherein the instructions enable the one or more controllers to prevent shutdown of the fuel cell stack in response to the output voltage of the fuel cell stack being maintained at a first voltage or less for a first time or more, or in response to a cell voltage deviation of the fuel cell stack being maintained at a first voltage deviation or greater for the first time or more; and
wherein the instructions enable the one or more controllers to increase the heat generation amount of the fuel cell stack in response to the output voltage of the fuel cell stack being maintained at a second voltage or greater for a second time or more, or in response to a cell voltage deviation of the fuel cell stack being maintained at a second voltage deviation or less for the second time or more.

20. The system of claim 11, wherein the instructions enable the one or more controllers to monitor one of or any combination of the output voltage, an output current, a cell voltage deviation, a coolant temperature, and an air outlet temperature of the fuel cell stack and to terminate the cold start in response to satisfying a cold start completion condition.
